(19) United States
(12) Patent Application Publication
(10) Pub. No.: US 2006/0041915 A1
(43) Pub. Date: Feb. 23, 2006

(54) Residential gateway system having a handheld controller with a display for displaying video signals

(75) Inventors: Nevenka Dimitrova, Yorktown Heights, NY (US); Roli Wendorf, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,697

(22) PCT Filed: Dec. 10, 2003
(86) PCT No.: PCT/IB03/05880

§ 371 Date: Jun. 16, 2005

Related U.S. Application Data
(60) Provisional application No. 60/434,579, filed on Dec. 19, 2002.

(51) Int. Cl. H04N 7/18

(52) U.S. Cl. 725/81; 725/80

(57) ABSTRACT

A residential gateway system includes a residential gateway to which a plurality of video and audio signal recording and reproducing devices, video and audio sources, including satellite, cable, Internet, are connected, and including a handheld controller for communicating with and controlling the residential gateway. The handheld controller has a display screen for displaying icons for controlling the residential gateway, and for displaying video signals from the residential gateway. Since the display capabilities of the display screen of the handheld controller are limited, the residential gateway includes a transcoder for transcoding video signals for transmission to the handheld controller such that the transmitted video signals may be displayed in their entirety on the display screen of the handheld controller. By transcoding the video signals prior to transmission, valuable bandwidth of the network channel connecting the handheld controller to the residential gateway is save for the transmission of other information and signals.

### FIELD OF THE INVENTION

The subject invention relates to a residential gateway for accessing various broadcast media as well as various storage and display media, and to a handheld device for communicating with and controlling said residential gateway.

### DESCRIPTION OF THE RELATED ART

The introduction of cable modems and broadband services to cable television systems has given rise to the development of residential gateway systems. These systems couple the digital and analog television hybrid fiber coax cables to telephones, computers, facsimile machines, set-top boxes, digital video recorders, etc., for bi-directional digital communication with the suppliers of these services, and for receiving conventional analog downstream broadcasts. These systems can implement video on demand, broadband Internet access, monitoring of security camera video, interactive games, and a host of other applications.

Published U.S. Patent Application No. US 2002/0044225, published Apr. 18, 2002, discloses such a system in which a handheld remote control, coupled to the residential gateway via infrared or radio frequency (RF) transmissions, is used to control the data processed by the residential gateway and displayed on a display coupled to the residential gateway. As disclosed therein, the handheld remote control may include a display whereby the operator of the system is able to preview movies and the programs on other channels before purchasing the movie or changing the channel being viewed on the main display to the channel being previewed on the handheld remote control.

Published U.S. Patent Application No. US 2002/0002707, published Jan. 3, 2002, also discloses such a system in which the handheld device may not be capable of displaying the content of the received video stream in its entirety, and therefore, presents a portion of the content on the contained display.

In each of the above systems, the video stream in its entirety is transmitted to the handheld device, regardless of the capabilities of the handheld device. This exacts a high toll on the communications channel with the handheld device.

It is an object of the present invention to provide a residential gateway system having a handheld controller for communicating with and controlling the residential gateway system, in which the communication channel between the residential gateway system and the handheld controller is used efficiently.

It is a further object of the present invention to provide a residential gateway system having a handheld controller for communicating with and controlling the residential gateway system, in which information is provided to the handheld controller in a format desired by a particular user.

It is a further object of the present invention to provide a residential gateway system having a handheld controller for communicating with and controlling the residential gateway system, in which, in response to a preference of a particular user, the residential gateway autonomously provides information to the handheld device for display on the display.

This object is achieved in a residential gateway system comprising means for receiving broadcast video signals from a variety of sources; means for displaying video signals; a residential gateway coupled to said receiving means for selectively displaying video signals on said display means; and a handheld controller having a display screen, said handheld controller being coupled to said residential gateway via a network channel for communicating with and controlling said residential gateway, wherein said residential gateway comprises means for storing attributes of said handheld controller and of said network channel; and transcoding means for transcoding video signals, in response to said stored attributes, for transmission on said network channel to said handheld controller, said transcoded video signals being capable of being handled by said network channel, and of being displayed on the display screen of said handheld controller without further processing in said handheld controller.

Applicants have found that when the video signal in its entirety is transmitted to the handheld controller, when the handheld controller cannot display this video signal as such, the capacity of the network channel is being unnecessarily used, since the handheld controller must transcode the video signal before being able to display the same. If the video signal is transcoded prior to transmission, other information, including other video signals may be simultaneously transmitted to (and from) the handheld controller up to the capacity of the network channel.

In an embodiment of the residential gateway system of the subject invention, the attributes of the network channel and the handheld controller comprise the bandwidth capabilities of the network channel and the display screen, including the resolution and refresh rate of the display screen, and the transcoding means transcodes the video signals to conform with at least the bandwidth of the display screen.

In such a residential gateway system, the transcoding means of the residential gateway takes the bandwidth capabilities of the network channel and the display screen into consideration when transcoding the video signals. As such, the transmitted video signals are tailored to the capabilites of the display screen of the handheld device and needless information is not transmitted to the handheld device.

In a further embodiment of the residential gateway system of the subject invention, the residential gateway system further comprises means for storing video signals and for playing back stored video signals, and the transcoding means is additionally capable of transcoding stored video signals by performing a video content analysis, and wherein the video content analysis comprises, alternatively, providing a series of still images and a text summarization of the stored video signals, and providing a series of relevant video and audio.

In such a residential gateway system, a recording means and playback means is included for recording and/or playing back recorded video signals. As such, while the transcoding means may tailor the bandwidth of the recorded video signals transmitted to the display screen, the transcoding means may alternatively analyze the video content of the stored video signal and supply, alternatively, a series of still images and a text summarization of the stored video signal, and a series of relevant video and audio clips of the stored video signal.

With the above and additional objects and advantages in mind as will hereinafter appear, the invention will be described with reference to the accompanying drawings, in which:

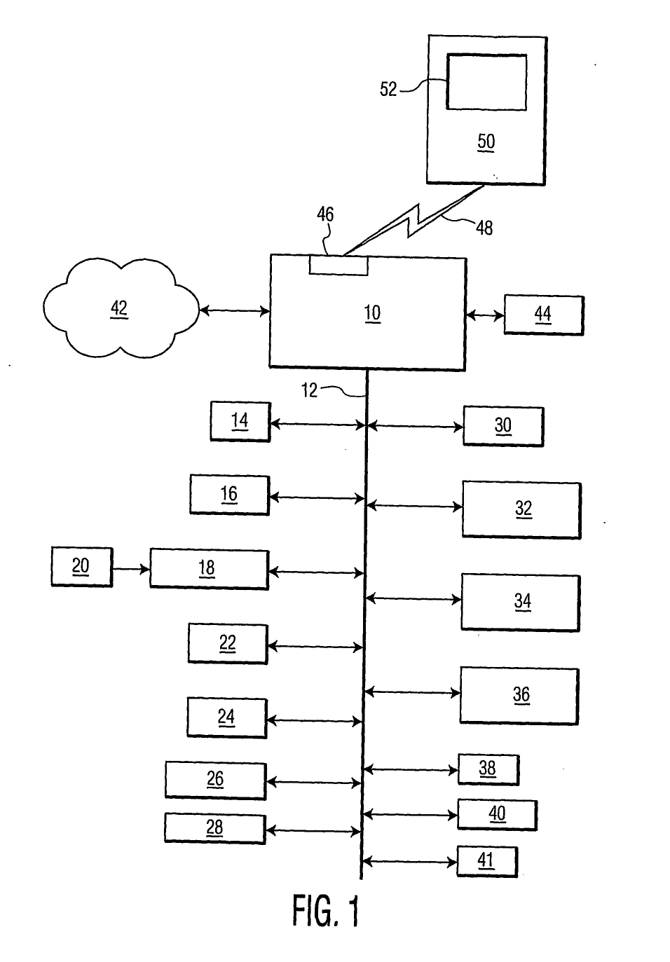

FIG. 1 is a functional block diagram of a residential gateway system;

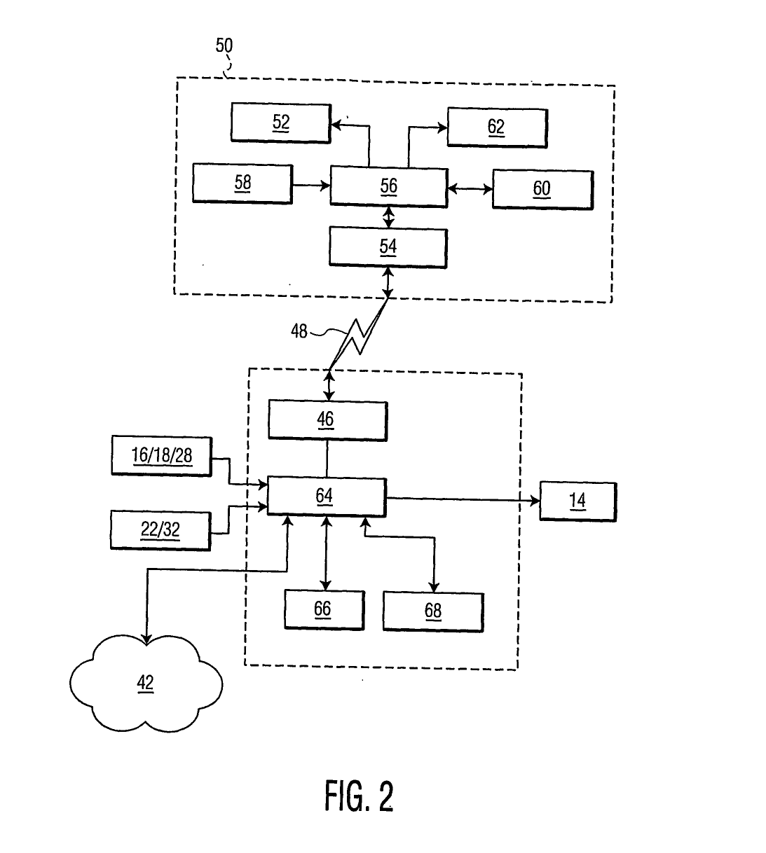

FIG. 2 is a detailed block diagram of the handheld controller and the residential gateway in the residential gateway system of FIG. 1;

FIG. 3 is a layout of a portion of the memory in the handheld controller of FIG. 2;

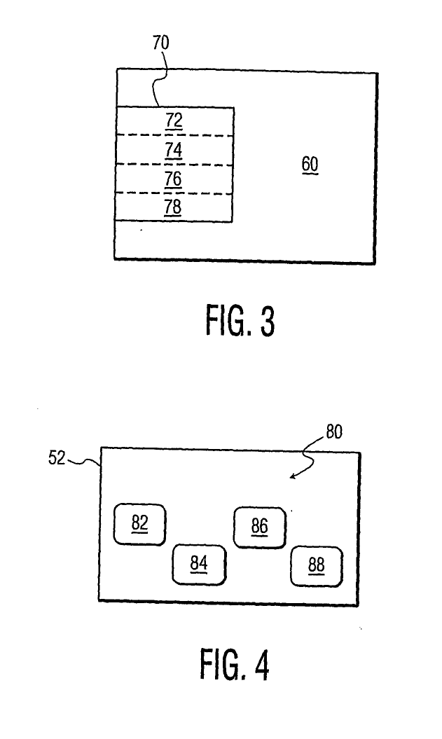

FIG. 4 shows a proposed display on the display screen of the handheld controller when the handheld controller is turned on;

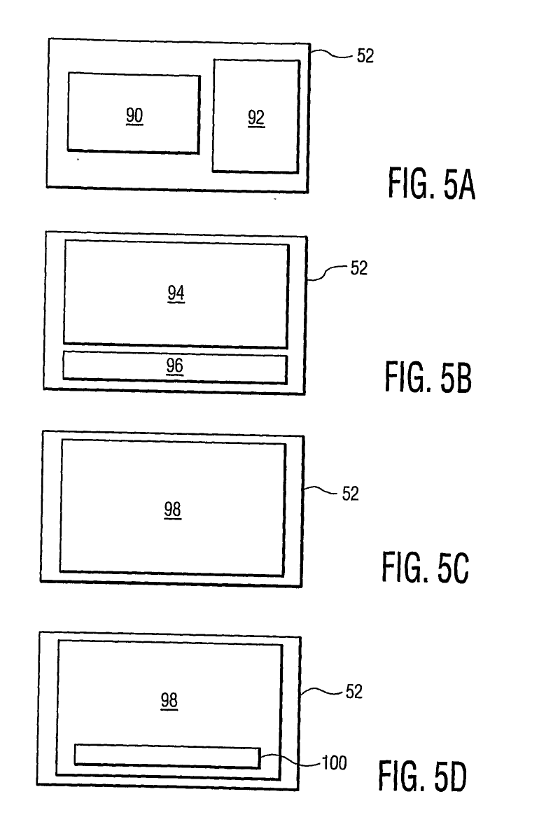

FIGS. 5A-5D show sample displays on the handheld controller in response to the selected user and user profile; and

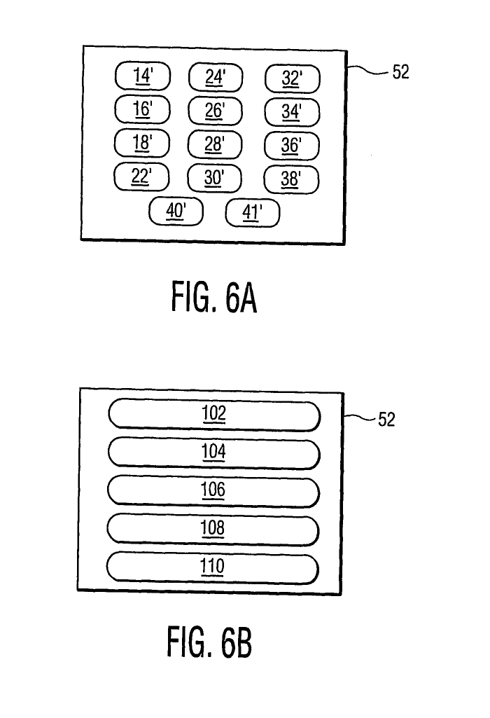

FIGS. 6A and 6B show sample displays on the handheld controller in response to selecting direct user control of the residential gateway system.

As shown in FIG. 1, a residential gateway system includes a residential gateway 10 having a bus 12 for connecting the residential gateway to a television receiver 14, a set-top box 16, a satellite receiver 18 and associated satellite antenna 20, a DVD player 22, an audio system 24, a telephone 26, a cable television connection 28, a VCR 30, a digital video recorder 32, a digital audio recorder 34, an analog audio recorder 36 (for example, a cassette recorder), a facsimile machine 38 a telephone communication connection 40, and a personal computer (PC) 41. The residential gateway 10 is further provided with a connection to the Internet 42, and also includes a memory 44 connected thereto. It should be understood that these devices are exemplary and that other devices may also, or alternatively, be connected to the residential gateway 10.

The residential gateway 10 further includes a transceiver 46 for transmitting and receiving information over a network 48 to and from a handheld controller 50 having a display screen 52. While the network 48 is shown as being wireless, e.g., infrared or RF, the network may also be a wired connection.

The handheld device 50 further includes, as shown in FIG. 2, a transceiver 54 for receiving information from and applying information to the network 48, and a processor 56 for processing the information and for selectively applying video signals to the display 52. The handheld device 50 further includes a keyboard 58 for receiving instructions from a user, as well as a memory 60 for storing information. A loudspeaker 62 is also provided for reproducing audio signals. Alternatively, a headphone jack (not shown) may be provided for the reproduction of audio signals.

The residential gateway 10 includes a processor 64 coupled to the transceiver 46 for receiving, among other, broadcast video signals from broadcast inputs, for example, the satellite receiver/antenna 18, 20, the set-top box 16, and the cable connection 28, and from stored inputs, for example, the DVD player 22, the VCR 30, and the digital video recorder 32. The processor 64 has a memory 66 connected thereto for storing information and a transcoder 68 for selectively transcoding video signals. Memory 66 may be the same as, or in addition to, memory 44. The processor 64 selectively applies video signals to a display, for example, television receiver 14, and information, which may include transcoded video signals to the transceiver 46 for transmission to the handheld controller 50.

The transcoder 68 performs a compression based media transcoding of the applied video signal. For example, the resolution of an HDTV signal is reduced to that which is displayable by the display screen 52 of the handheld controller 50. In the case of stored video signals, the transcoder 68 relies on video content analysis. To that end, the transcoded signal may include a series of still images and a text transcript of the video content. Alternatively, the transcoded signal may include a series of video clips summarizing the important moments of the video content. Further, via the connections to the Internet 42, the satellite receiver 18 and antenna 20, the cable 28 and the telephone line 40, the residential gateway 10 has access to news, weather, traffic and other live information. To that end, the transcoder 68 transcodes this information by generating a text streamer for application to the display screen 52 of the handheld controller 50.

It is envisioned that the residential gateway system may be used by various members in a family residing in the residence. To that end, it would be desirable if the display on the display screen 52 of the handheld controller 50 were tailored to the desires of the various family members. FIG. 3 shows an graphical organization of the memory 60 in the handheld controller 50. The memory 60 includes a profiles section 70 for storing the profiles 72-78 of, for example, 4 different users. FIG. 4 shows a display on the display screen 52 of the handheld controller 50, which in this case is touch sensitive. When the handheld controller 50 is turned on, the display screen 52 displays the message 80 “WHO ARE YOU?” along with 4 icons 82-88, corresponding to the stored profiles 72-78, respectively. When the user touches the appropriate icon, the corresponding profile is transmitted to the residential gateway 10 for storage in the memory 66. After selecting the appropriate icon 82-88, the handheld controller 50 begins displaying transcoded video images in accordance with the profile of the selected user icon.

FIGS. 5A-5D shows sample images on display screen 52 corresponding to various modes of the transcoder 68. In particular, in FIG. 5A, a stored video signal has been selected and the transcoder 68 provides a sequence of still images or video clips 90 as well as a text summary 92 of the stored video program. In FIG. 5B, a currently broadcast video signal 94 is being viewed, while a live update text streamer 96 is displayed at the bottom of the display screen 52 giving, for example, stock quotes, the latest news headlines, weather, traffic conditions, sports scores, etc. In FIG. 5C, a currently broadcast video signal 98 is being displayed, while the audio portion is reproduced through the loudspeaker 62. In FIG. 5D, the currently broadcast video signal 98 of FIG. 5C is displayed. Instead of the audio portion being reproduced, closed caption sub-titling 100 is shown.

The residential gateway uses an optimization method to determine the best media rendering from all of the parameters of the input devices as well as the network 48 and the handheld controller 50, for example, screen size, resolution, processing power, battery life, available network bandwidth, user priorities for topics, time of day, location, available time for watching previews (e.g., visual table of contents) and full-length videos. This may include a weighted scheme for the different parameters, where the preference for user's priority has a higher weight than other parameters.

It should be understood that the handheld controller 50 may be used in the classical sense of directly controlling the operation of the residential gateway system. To that end, by operating an appropriate button on the keyboard 58, the display screen 52 may then show icons representing all of the components attached to the residential gateway 10 (see FIG. 6A). For convenience, FIG. 6A shows the icons as the primed reference numbers of the components 14-41 shown in FIG. 1 connected to the residential gateway 10 via the bus 12. If, for example, the user selects the digital video recorder 32 by touching the icon 32′, a new display is shown on the display screen 52. As shown in FIG. 6B, a listing and summarization of all the stored video programs is displayed as separate icons 102, 104, 106, 108 and 110. Once the program is selected, the user may then have the selected video program displayed on the television receiver 14, or displayed on the display screen 52 of the handheld controller 50, at which the transcoder 68 transcodes the stored video signal to the bandwidth of the display screen 52 and the residential gateway 10 transmits the transcoded video signal to the handheld controller 50 using the transceiver 46.

The handheld controller 50 is able to get an overview with audio-visual summaries of all the programs on, for example, the digital video recorder 32, and the movies/pages on the PC 41. These summaries may be generated by the input device itself (the digital video recorder 32 or the PC 41) or by the processor 64. The user of the handheld controller 50 may then use these audio-visual summaries to decide what to watch, what to delete and what else to record. In addition, if a visual table of contents is available for the programs (for example, in metadata accompanying the video signal or accessed from a pertinent Internet site), then the user can identify sub-segments (scenes) of the program that should be deleted and which portions should be kept on the device. This feature may also be used to “lock” certain programs and sub-segments of programs from a parental control point of view. As such, a parent can predetermine which visual scenes should be deleted and then make the “edited) movie available for general viewing in the household. This is handy because the viewing area of the handheld controller 50 is relatively small and private. The parent can then watch the movie with deleted scenes on the handheld controller 50. In addition, the user can decide to highlight, bookmark or e-mail certain portions to other users based on the marked scenes in the visual table of contents.

Numerous alterations and modifications of the structure herein disclosed will present themselves to those skilled in the art. However, it is to be understood that the above described embodiment is for purposes of illustration only and not to be construed as a limitation of the invention. All such modification which do not depart from the spirit of the invention are intended to be included within the scope of the appended claims.

1. A residential gateway system comprising:
means (18, 20, 28, 42) for receiving broadcast video signals from a variety of sources;
means (14) for displaying video signals;
a residential gateway (10) coupled to said receiving means (18, 20, 28, 42) for selectively displaying video signals on said display means (14);
a handheld controller (50) having a display screen (52), said handheld controller (50) being coupled to said residential gateway (10) via a network channel (48) for communicating with and controlling said residential gateway (10),
wherein said residential gateway (10) comprises:
means (44, 66) for storing attributes of said handheld controller (50) and of said network channel (48); and
transcoding means (68) for transcoding video signals, in response to said stored attributes, for transmission on said network channel (48) to said handheld controller (50), said transcoded video signals being capable of being handled by said network channel (48), and of being displayed on the display screen (52) of said handheld controller (50) without further processing in said handheld controller (50).

2. The residential gateway system as claimed in claim 1, wherein said attributes of said network channel (48) and said handheld controller (50) comprise the bandwidth capabilities of the network channel (48) and the display screen (52), including the resolution and refresh rate of the display screen (52), screen size, processing power, and battery life, and the transcoding means (68) transcodes the video signals to conform with at least the bandwidth of the display screen (52).

3. The residential gateway system as claimed in claim 2, wherein said residential gateway system further comprises means (22, 30, 32, 41) for storing video signals and for playing back stored video signals, and said transcoding means (68) is capable of transcoding stored video signals by performing a video content analysis.

4. The residential gateway system as claimed in claim 3, wherein said video content analysis comprises, alternatively, providing a series of still images and a text summarization of the stored video signals, and providing a series of relevant video clips and audio clips.

5. The residential gateway system as claimed in claim 3, wherein said residential gateway system further comprises means (18, 20, 28, 42) for receiving news, weather, traffic and other live information, and said transcending means (68) is capable of transcoding said live information in the form of a text streamer for transmission to said handheld controller.

6. The residential gateway system as claimed in claim 4, wherein said handheld controller (50) further comprises a memory (60) for storing profile information concerning a plurality of users of said handheld controller (50), said profile information including guidelines of which transcoding process is desired by the selected user.

7. The residential gateway system as claimed in claim 5, wherein said handheld controller (50) further comprises a memory (60) for storing profile information concerning a plurality of users of said handheld controller (50), said profile information including guidelines of which transcoding process is desired by the selected user, and wherein said residential gateway (10) comprises means for autonomously providing said transcoded text streamer to said handheld controller (50) based on a priority setting in said user profile.

8. The residential gateway system as claimed in claim 6, wherein said profile information includes user priorities for topics, time of day, location, available time for watching previews and full-length videos, said residential gateway (10) using the attributes of the network channel (48) and the handheld controller (50), as well as attributes of the video signals, in a weighting scheme along with said user priorities for determining the transcoding process to be performed by the trancoding means (68), wherein said user priorities are highest weighted.

9. The residential gateway system as claimed in claim 3, wherein the residential gateway (10) provides audio-visual summaries of the video signals stored on the video signal storing and playback means (22, 30, 32, 41), said audio-visual summaries including images representing scenes in the video signals.

10. The residential gateway system as claimed in claim 3, wherein the residential gateway (10) provides a table of contents for each of the programs represented by video signals stored by the video signal recording and playback means (22, 30, 32, 41), said transcoding means (68) transcoding said table of contents for said handheld controller (50), said handheld controller (50) displaying said table of contents, and said handheld controller (50) having means (56) for selectively deleting selected portions of a selected one of the programs thereby forming an edited program, said edited program being subsequently displayed on said displaying means (14).

11. The residential gateway system as claimed in claim 10, wherein said table of contents is stored with the video signals of each of the programs.

12. The residential gateway system as claimed in claim 10, wherein said table of contents is obtained from the Internet by the residential gateway system.

13. The residential gateway system as claimed in claim 10, wherein said handheld controller (50) comprises lock-out means (56) for locking out selected programs or portions of programs from being viewed on the displaying means (14) or on the handheld controller (50).
